(19) United States
(12) Patent Application Publication
(10) Pub. No.: US 2007/0285501 A1
(43) Pub. Date: Dec. 13, 2007

(54) Videoconference System Clustering

(76) Inventor: Wai Yim, San Jose, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/423,394

(22) Filed: Jun. 9, 2006

(51) Int. Cl. H04N 7/14

(52) U.S. Cl. 348/14.08

(57) ABSTRACT

A videoconferencing cluster system is described that has at least one cluster node server and a master server configured to communicate with the cluster node server and an outside client over a wide area network. Each cluster node server is configured to communicate with a plurality of cluster node clients and send and receive audio and video information to and from the cluster node clients. The cluster node servers are configured to send and receive audio and video information to and from the master server. The master server sends and receives the audio and video information to and from each of the cluster node servers and the outside client such that each user of each outside client and each cluster node client can see, hear, and interact with each other in real time.

### CROSS REFERENCE TO RELATED APPLICATIONS

This application is related to U.S. patent application Ser. No. 10/192,130 filed on Jul. 10, 2002 and entitled “Method and Apparatus for Controllable Conference Content Via Back-Channel Video Interface;” U.S. patent application Ser. No. 10/192,080 filed on Jul. 10, 2002 and entitled “Multi-Participant Conference System with Controllable Content Delivery Using a client monitor Back-channel;” U.S. patent application Ser. No. 10/681,732 filed on Oct. 8, 2003 and entitled, “Connectionless TCP/IP Data Exchange;” U.S. patent application Ser. No. 11/051,674 filed on Feb. 4, 2004 and entitled “Adaptive Bitrate Adjustment of Multimedia Communications Channel Using Transport Control Protocol;” U.S. patent application Ser. No. 11/340,062 filed on Jan. 25, 2006 and entitled, “IMX Session Control and Authentication;” and U.S. patent application Ser. No. 11/199,600 filed on Aug. 9, 2005 and entitled “Client-Server Interface to Push Messages to the Client Browser” all of which are incorporated herein by reference.

### BACKGROUND

Conferencing systems are used to facilitate communication between two or more participants physically located at separate locations. Systems are available to exchange live video, audio, and other data to view, hear, or otherwise collaborate with each participant. Common applications for conferencing include meetings/workgroups, presentations, and training/education. Today, with the help of videoconferencing software, a personal computer with an inexpensive camera and microphone can be used to connect with other conferencing participants. Peer-to-peer videoconferencing software applications allow each participant to see, hear, and interact another participant and can be inexpensively purchased separately. Motivated by the availability of software and inexpensive camera/microphone devices, videoconferencing has become increasingly popular.

Video communication relies on sufficiently fast networks to accommodate the high information content of moving images. Audio and video data communication demand increased processor power and bandwidth requirements as the number of participants and the size of the data exchange increase. Even with compression technologies and limitations in content size, bandwidth and processing power limits restrict the number of conference participants that can readily interact with each other in a multi-party conference.

It would be desirable to scale conferencing system implementations beyond current limits imposed by processing power available at a particular server.

### SUMMARY

Broadly speaking, the present invention fills these needs by providing a videoconference system cluster. It should be appreciated that the present invention can be implemented in numerous ways, including as a process, an apparatus, a system, a device, or a method. Several inventive embodiments of the present invention are described below.

In one embodiment, a videoconferencing cluster system is provided that has at least one cluster node server and a master server configured to communicate with the cluster node server and an outside client over a wide area network. Each cluster node server is configured to communicate with a plurality of cluster node clients and send and receive audio and video information to and from the cluster node clients. The cluster node servers are configured to send and receive audio and video information to and from the master server. The master server sends and receives the audio and video information to and from each of the cluster node servers and the outside client such that each user of each outside client and each cluster node client can see, hear, and interact with each other in real time.

In another embodiment, a method for enabling a plurality of videoconference attendees to see and hear each other is provided. Audio and video information is transmitted from an outside client to the master node server over the wide area network. Additional audio and video information is transmitted from a plurality of cluster node clients to a cluster node server. At least a portion of the audio and video information received by the cluster node server from the cluster node clients is transmitted to the master server. Audio and video information received by the master server is combined into a composite audio and video stream for the outside client and the cluster node server. Each composite audio and video stream is transmitted to a corresponding one of the outside client and the cluster node server. Finally, the composite audio and video stream received by the cluster node server is transmitted to the cluster node clients.

In yet another embodiment, a graphical user interface for a videoconferencing system is provided. The graphical user interface includes a video window. The video window displays a master composite video stream originating from a master server. The master composite video stream includes downsampled views, at least one view being a downsampled image of an outside attendee, wherein the outside attendee is connected directly to the master server over a wide area network. At least one other view shows a downsampled image of a local composite video stream. The local composite video stream originates from a cluster node server and includes a plurality of local views of attendees connected to the cluster node server. The cluster node server generates the local composite video stream from a plurality of downsampled local streams originating from cluster node clients to the cluster node server over a local area network.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 provides an overview schematic diagram depicting an exemplary videoconference system cluster.

FIG. 2 shows a schematic representation of an exemplary computer.

FIG. 3 shows a schematic block diagram showing high-level software components running on a cluster node server.

FIG. 4 shows an exemplary graphical user interface.

FIG. 5 shows a flowchart presenting an exemplary procedure carried out by the conferencing system of FIG. 1.

FIG. 6 shows a flowchart depicting an exemplary procedure for creating and connecting to a conference using the conferencing system of FIG. 1.

### DETAILED DESCRIPTION

In the following description, numerous specific details are set forth in order to provide a thorough understanding of the present invention. However, it will be apparent to one skilled in the art that the present invention may be practiced without some of these specific details. In other instances, well known process operations and implementation details have not been described in detail in order to avoid unnecessarily obscuring the invention.

A computer cluster is a group of loosely coupled computers that work together to solve problems, thereby multiplying their individual processing power. There are many different types of computer clusters. For instance, some clusters provide hardware redundancy for improved availability; some provide load-balancing functions whereby network traffic is routed through a front end for distribution to a back end cluster of servers. Other clusters split computational tasks into smaller elements and distributes them throughout a cluster for parallel processing. Because of the conceptual nature of computer clusters, the term, “cluster” in the present context should be understood to have a broad general meaning.

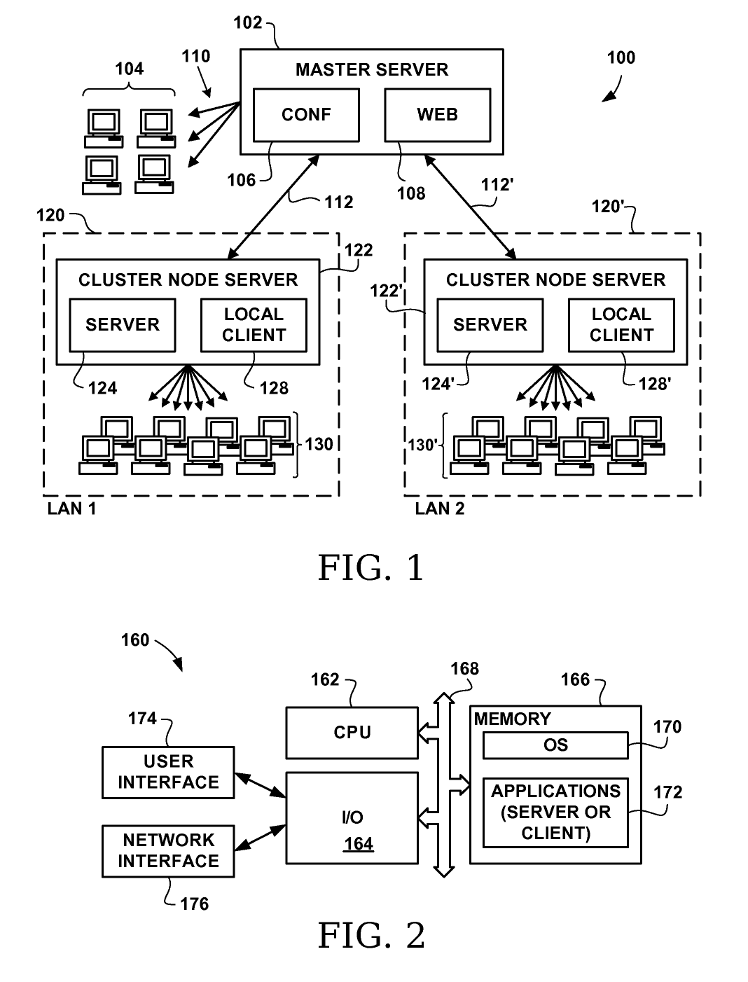

FIG. 1 provides an overview schematic diagram depicting an exemplary videoconference system cluster 100, which includes a master server 102 and one or more cluster node servers 122, 122′. In one embodiment, master server 102 executes a conferencing server program 106 and a web server program 108. Conferencing server program 106 communicates with one or more external clients 104 over network connections 110. Web server program 108 provides a user interface for creating and scheduling meetings, logging in and out, and changing preferences. In one embodiment, an outside user controlling a client 104 can enter a meeting by logging into master server 102 by accessing web server program 108, causing the web server program to trigger a browser plug-in that launches the user's conference client program.

Network connections 110 may, for example, be Internet connections. Each external client 104 is operated by a meeting attendee. The master server 102 and the external clients 104 allow each meeting attendee to see and hear each other in real time using videoconferencing technology as described in related U.S. patent applications Ser. Nos. 10/192,130 and 10/192,080, which are incorporated by reference herein. By “real time” it is meant that a transmission sent from one user is received by other users in an amount of time that depends primarily on network latency.

In addition to external clients 104, cluster node servers 122, 122′ are in communication with master server 102. With respect to master server 102, each cluster node server 122, 122′ behaves similarly to an individual external client 104 as will be described in more detail herein below.

Each cluster node server 122, 122′ lives in a corresponding local area network 120, 120′ and connects with master server 102 over one or more network connections 112, 112′, which may, for example, be over a wide area network such as the Internet. Each cluster node server 122, 122′ also connects to a plurality of cluster node clients 130, 130′ over local area connections. That is, the cluster node server 122, 122′ are each on the same local area network (LAN) 120, 120′ as the respective cluster node clients 130, 130′. In addition, each cluster node server 122, 122′ includes a respective local client 128, 128′. Users of cluster node clients 130 and local clients 128 can see and hear each other by passing audio and video information through cluster node server 122. In addition, users of cluster node clients 130′ and local client 128′ can see and hear each other by passing audio and video information through cluster node server 122′. Finally, users of cluster node clients 130, 130′ and local clients 128, 128′ and external clients 104, can all see and hear each other by passing audio and video information through master server 102. In addition to seeing and hearing each other, user data such as documents, annotations, and live desktop views can be transmitted to other users from any user's location.

Master server 102, cluster node server 122, outside clients 104, and cluster node clients 130 each comprise a multipurpose computer system. FIG. 2 shows an exemplary multipurpose computer system 160 having a central processing unit (CPU) 162, input/output (I/O) ports 164, and a memory 166, which are in electronic communication via bus 168. Memory 166 includes an operation system 170 and applications 172. If computer 160 is a server, then applications 172 will include server software. If computer 160 is a client, then applications 172 will include client software. It is also possible that computer 160 act as both a server and a client, in which case, applications 172 will include server software as well as client software. Herein, the term, “server” will refer to a computer system that has server functionality, and the term “client” will refer to a computer system that primarily acts as a client, although it should be understood that each can act in either capacity or both simultaneously, depending upon the software being run. Each server may provide multiple server functions. For example, a single server computer, e.g., master server 102, could include conferencing software 106 as well as web server software 108. Each server application may include multiple processes that run concurrently. I/O ports 164 can be connected to external devices, including user interface 174 and network interface 176. User interface 174 may include user interface devices, such as a keyboard, video screen, and a mouse. In the case of external clients 104, local clients 128, 128′ and cluster node clients 130, user interface devices may also include a microphone and video camera. Network interface 176 may include one or more network interface cards (NICs) for communicating via an external network.

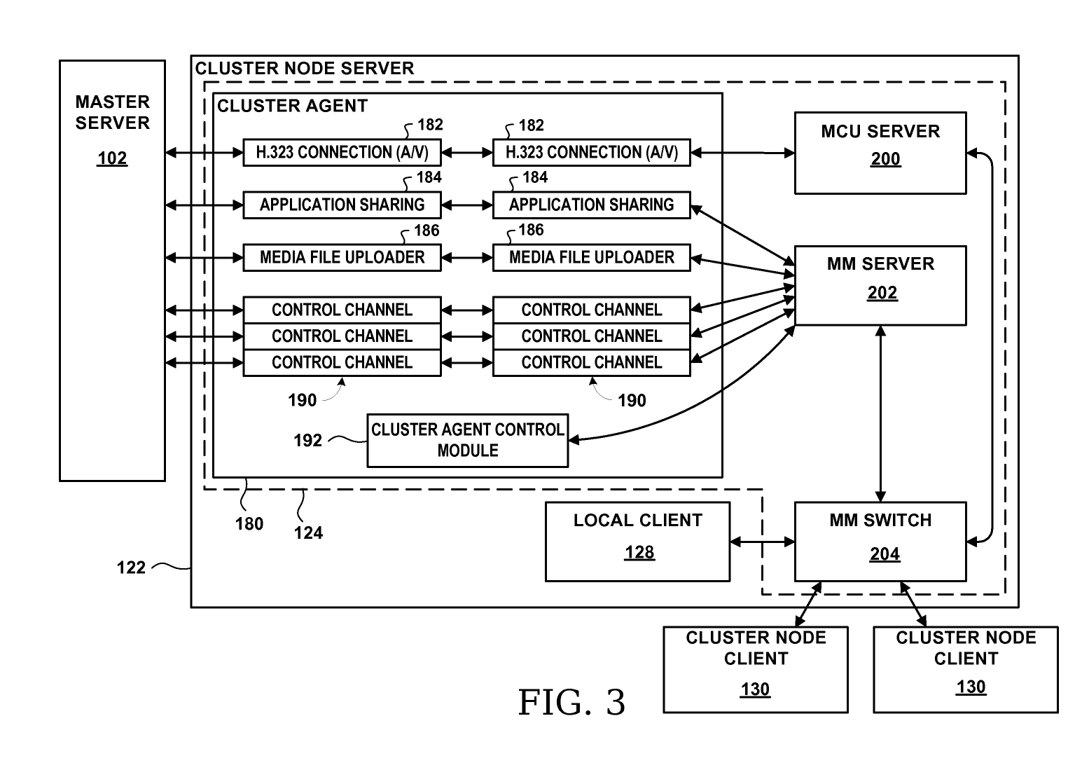

FIG. 3 shows a schematic block diagram showing high-level software components running on cluster node server 122 and interactions with master server 102 and cluster node clients 130. It should be noted that cluster node server 122 represents a computer system that may be operated by an attendee to a videoconference. Specifically, the attendee may interact with other attendees using the local client 128, which is a process running on cluster node server 122. In this way, the cluster node server 122 is acting as both a server computer and a client computer. In one embodiment, server processes are hidden from the user. As mentioned previously, the system shown is exemplary, and various server components may be spread across additional server computers or combined into fewer computers. Functionality provided by multiple software applications or processes may be combined into a fewer applications or divided into a greater number of applications, depending on the implementation. In the present example, cluster node server 122 includes a cluster agent 180, multipoint control unit server (MCU) 200 a media management (MM) server 202, an MM switch 204, and a local client 128. Each process runs within cluster node server 122 and communicate as indicated by the connecting lines in FIG. 3. Inter-process communication between each of the processes may be achieved by any available mechanism such as that provided by the platform, e.g., the hardware and operating system elements (not shown) of cluster node server 122.

MM switch 204 directs data traffic flowing between the server processes, MCU server 200 and MM server 202 and the connected clients, which include local client 128 and cluster node clients 130. MM switch 204 maintains connections to the external cluster node clients 130 over a local area network connection. In one embodiment, local client 128 communicates to MM switch 204 over a local “virtual” connection within cluster node server 122. In another embodiment, local client 128 communicates by other known means, such as by an inter-process communication mechanism provided by the platform. MM switch 204 connects the connected clients to MCU server 200 and MM server 202 through inter-process communication or other means. With regard to audio-video streams, MM switch pass audio-video information from each connected client to MCU server 200, and a composite audio-video received from master server 102 to each connected client.

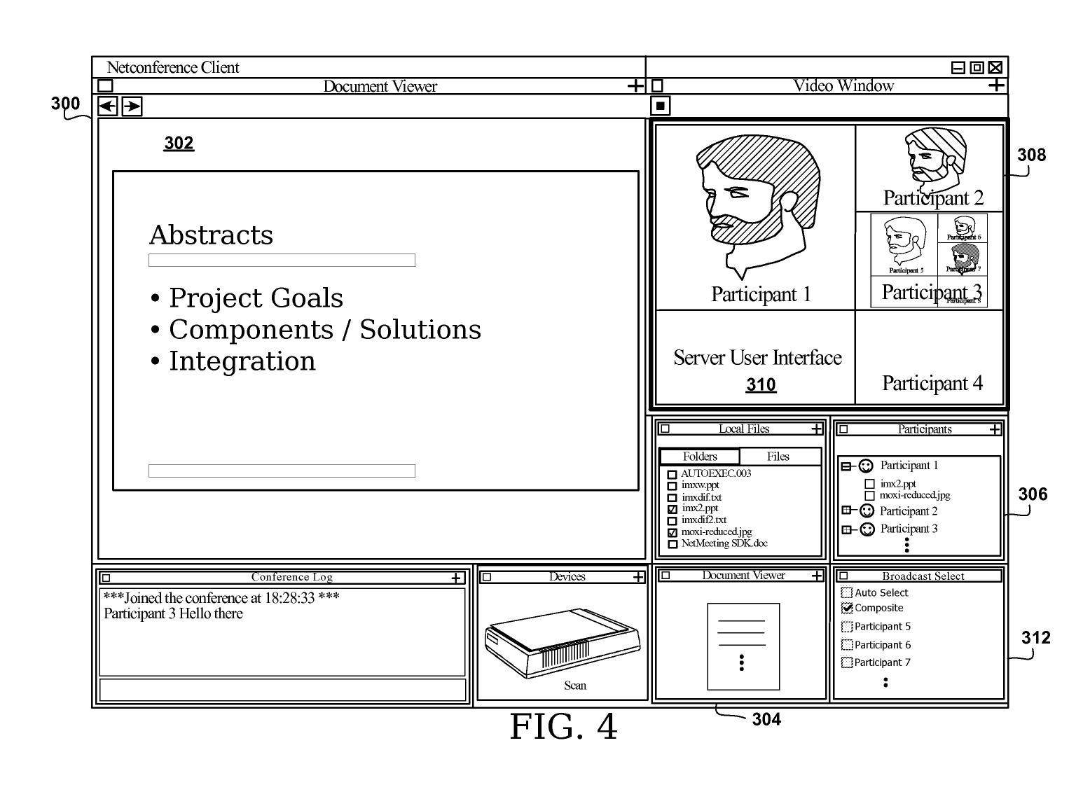

MCU server 200 receives audio and video streams from MM switch 204, which receive them from local client 128 and cluster node clients 130. At least a portion of the audio and video streams received by MCU server 200 is transmitted to master server 102. In one embodiment, MCU server 200 combines the audio feeds and downsamples the video and generates a composite video which is than transmitted with the combined audio to master server 102 via cluster agent 180. In another embodiment, MM server 202 selects one of the videos for transmission to master server 102. The selection may be made automatically or manually. For instance, the cluster client having the loudest audio signal can be selected to be transmitted, whereas a manual selection can be made by local client 128 via a special interface as described in more detail below with reference to FIG. 4.

MM server 202 receives various data from local client 128 and cluster node clients 130 via MM switch 204. The data includes application sharing data, file and document sharing, and control signals. Application sharing data can include a live view of the user's desktop and/or data representing keyboard and/or mouse input. File and document sharing provides a mechanism to share documents or other fixed data for review by other attendees. The control signals relate to commands or status data sent and received from each client to the servers.

Cluster agent 180 includes H.323 connections 182 connecting MCU server 200 with master server 102 to transmit audio/video data to and from master server 102. H.323 is a codec and specification from the ITU Telecommunication Standardization Sector (ITU-T). H.323 is an industry standard codecs and protocol to provide audio-visual communication sessions on any packet network. In addition to video data, cluster agent 180 maintains an application sharing channel 184 for sending and receiving application sharing data to and from local client 128 and cluster node clients 130. Typically, only one conference attendee will be sharing his or her desktop at a time, so all application sharing data of connected clients can be handled with a single connection to master server 102. Media file uploader channel 186 for sharing document data is also shared by all users connecting to the conference via cluster node server 122. Control data is passed to and from master server 102 through individual control channels 190, one channel for each connected client.

Cluster agent control module 192 communicates with MM server 202 to provide a channel for receiving commands such as startup, shut down, configuration, etc., as would be apparent to those skilled in the art. Each data channel within cluster agent 180 includes a connection to MCU server 200 or MM server 202 and a connection to master server 102. The connections to MCU server and MMserver 202 may be provided by any available inter-process communications means provided by the platform. Connections to master server 102 are provided through an outside network, and may entail traversing a firewall as mentioned in related U.S. patent application Ser. No. 10/681,732, which is incorporated herein by reference.

FIG. 4 shows an exemplary graphical user interface 300 shown by clients connected to a videoconference as herein described. This exemplary embodiment provides a plurality of windows each providing the user with information or interaction capability. Two document windows 302 and 304 are shown. For illustration purposes, document window 302 shows a POWERPOINT® type slide presentation and document window 304 shows a text document. Participants window 306 shows a list of participants with documents being shared by each participant being listed under their names.

Video window 308 provides a composite video display of each participant identified by their name. For purposes of illustration, the terms, “Participant 1,” “Participant 2,” etc., are used in place of names. In this example, Participant 3 is a group which is connected by a cluster server. The cluster server has composited all the members of the group into a single video feed and presents the group as “Participant 3” to master server 102, which then composites that video with other videos received by other users to generate the display seen in video window 308. As mentioned previously, it is also possible to select an individual attendee or have the system automatically select one based on such factors as audio volume level.

In one embodiment, the configuration of video display 308 is user configurable by sending instructions to master server 102 from local client 128, or other connected client as assigned or selected by the cluster node server. As described in more detail in related U.S. patent application Ser. No. 10/192,080 which is incorporated herein, the videoconferencing system includes a client component and a server component. The client component includes a client monitor and a conference client. The client monitor captures input from the conference client. In one embodiment, the conference client is a peer-to-peer videoconferencing application. One example of a peer-to-peer videoconferencing application is MICROSOFT'S NETMEETING™ application. However, one skilled in the art will appreciate that any peer-to-peer videoconferencing application is suitable for the embodiments described herein. Thus, the system enhances pre-existing applications, which may already be installed on a personal computer, with increased functionality enabled through data provided by the client monitor. In addition, the client monitor can incorporate a graphical user interface (GUI) in which the video window of the peer-to-peer application is a component. The client monitor provides the captured input from the conference client to a server component. The captured input is transmitted to the server component which can dynamically modify the GUI being presented to a participant based on the captured input provided to the server component. For example, the client monitor can capture events, such as mouse clicks or mouse clicks in combination with keyboard strokes, executed by a user when his mouse pointer is within a region of the conference client that displays the video signal. In one embodiment, the events are transmitted through a back-channel connection to the server component for interpretation. Thus, the back-channel connection allows for active regions and user interface objects within the video stream to be used to control functionality and content. Consequently, users indirectly control how video is presented in different regions or can manipulate the layout based upon server processing of client events. As will be described below, additional communication exchange is available between participants using this system's back-channel connection.

Broadcast select window 312 therefore provides an interface for a selected user, e.g., the user of local client 128, to select how cluster node server 122 manages the multiple connected client video streams. It is also possible to allow or assign responsibility to one of cluster clients 130 to manage the broadcast select option. In the example provided, broadcast select window 312 includes an “Auto Select” option, and “Composite” option” and options for each connected client, which are each identified by their name. For purposes of illustration, the terms “Participant 5” “Participant 6” etc., are used in place of names and the cluster node is connected to master server 102 as “Participant 3” as shown in video window 308. When “Composite” is selected, the cluster node server generates a composite image of all users connected to the cluster node server; when “Auto Select” is selected, the cluster node server automatically selects which user's video feed to transmit to the master server. Such a selection may be based on a number of criteria, e.g., last person to speak based on audio signal loudness, length of time being broadcast, and random, etc. Other options are provided for manually selecting the video feed. Additional details relating to graphical user interface 300 are described in related U.S. patent application Ser. No. 10/192,080 which is incorporated herein by reference.

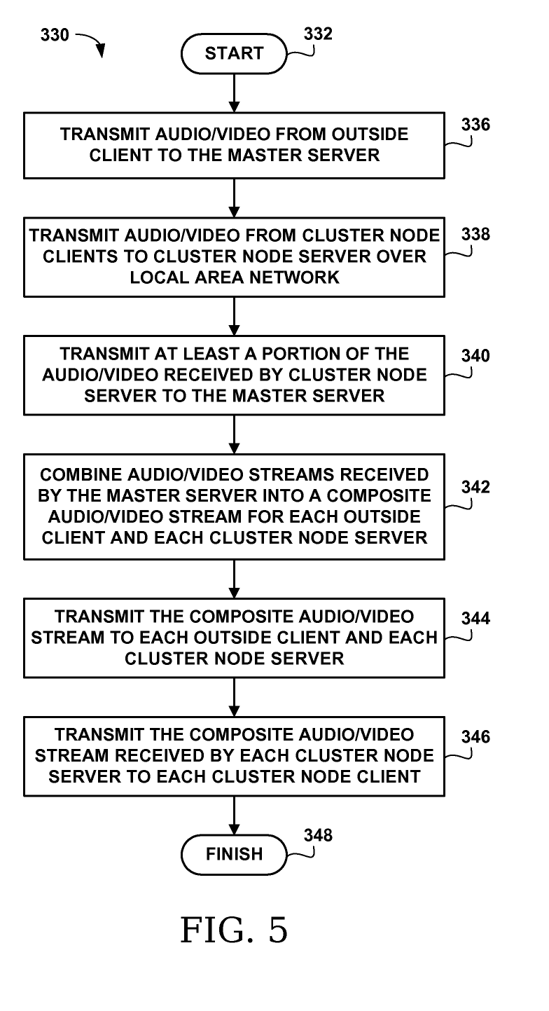

FIG. 5 shows a flowchart 330 presenting an exemplary procedure carried out by the conferencing system of FIG. 1. The procedure begins as indicated by start block 332 and flows to operation 336 wherein an audio/video stream is transmitted from each outside client 104 to master server 102. In one embodiment, these audio/video streams are transmitted over user datagram protocol/Internet protocol (UDP/IP) connections. At the same time, in operation 338, audio/video streams are transmitted from cluster node clients 130 and local client 128 to the cluster node server 122. Note that there may be any number of cluster node servers 122 limited only by processor and bandwidth speeds, and each cluster node server 122 may receive any number of audio/video streams from connected cluster node clients, again limited by bandwidth and processor speeds.

In operation 340, each cluster node server transmits at least a portion of the audio/video streams received by its connected cluster node clients and local client to the master server. The portion could be just a selected one of the video streams received from the clients or it could be a downsampled and composited version of video streams from all of the connected cluster node clients and local client. The composite audio/video stream that may be generated by a cluster node server is referred to herein as a “local composite stream.” With regard to the audio signals, all the audio signals from connected cluster node clients and the local client are combined into a single audio stream which may be packaged with the selected video stream or composited video stream.

In operation 342, the master server 102 combines the audio/video streams received from outside clients 104 and cluster node servers 122 into a composite audio/video stream. In one embodiment, the videos are downsampled and combined to form a composite image and the audio signals are added together. In one embodiment, the composite audio/video stream is customized for each outside client and cluster node server in accordance with their preferences and commands. Thus, each outside client and a selected user connected to each cluster node server can select from multiple layout options for the composite video.

In operation 344, each composite audio/video stream generated by the master server is transmitted to a respective one of the outside clients and cluster node servers. Thus, each outside client and each cluster node server receives the composite audio/video stream generated for their use. The cluster node servers, in operation 346, forward the composite audio/video stream received from the master server to the cluster node clients. In addition, if a local client is present on the cluster node server, the local client receives the composite audio/video stream as well. The procedure then ends as indicated by finish block 348.

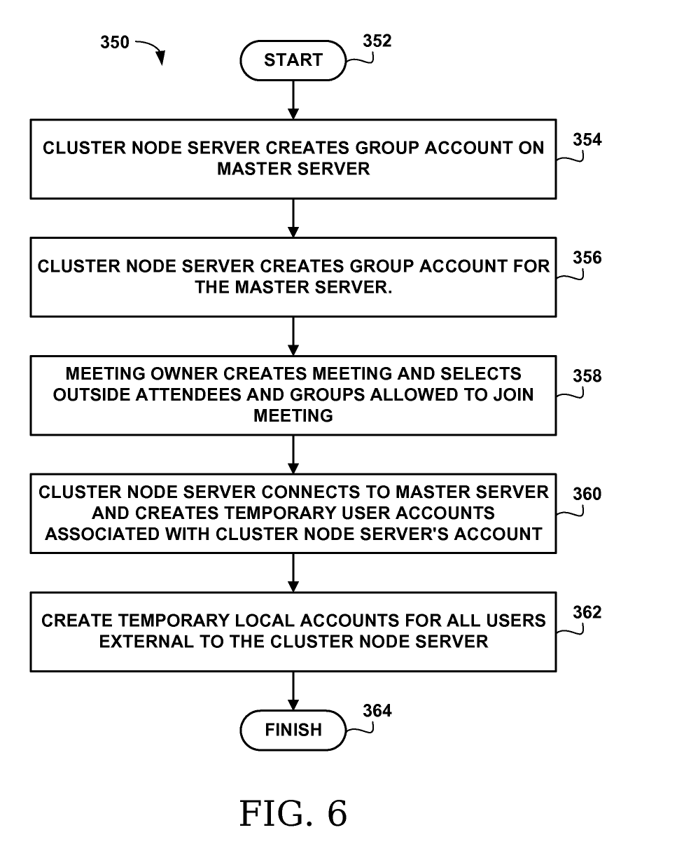

FIG. 6 shows a flowchart 350 depicting an exemplary procedure for creating and connecting to a conference using the conferencing system of FIG. 1. The procedure begins as indicated by start block 352 and proceeds to operation 354 wherein the cluster node server creates a group account on the master server. In one embodiment, the group account has a unique group name within the master server and its own password. Once the group account is created, the procedure flows to operation 356 wherein the cluster node server creates a group account for the master server. In one embodiment, a password is not necessary for the master server's group account on the cluster node server.

In operation 358, a meeting owner creates a meeting and selects outside attendees and groups allowed to join a meeting. If a particular attendee is a member of a group, they need not separately register with the master server. Outside attendees are individual users that access the master server directly, i.e., not through a cluster node server. Each outside attendee and group is given a unique username and password, which allows them to log in to the master server at the time of the meeting.

In operation 360, the cluster node server connects to the master server using its unique group name and password, and creates temporary accounts on the master server for each of its group members which are users connected to the cluster node server. This allows each of the users connecting through the cluster node server to be identified by others outside the cluster node. A control channel is established for each client connected to the cluster node server.

In operation 362, the cluster node server creates temporary local accounts for all users external to the node server. This allows each user connected through the cluster node server to identify and interact with individual users outside the cluster node. Individual cluster node server is fully responsible for whom to accept to participate in the videoconference call. The user's login information is kept on the individual cluster node server. As a result, the participant user authentication is distributed around the cluster.

Once the temporary accounts are created, the attendees are able to see, hear, and otherwise interact with each other through the conferencing system, and the procedure is completed as indicated by finish block 364.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Embodiments of the present invention can be processed on a single computer, or using multiple computers or computer components which are interconnected. A computer, as used herein, shall include a standalone computer system having its own processor(s), its own memory, and its own storage, or a distributed computing system, which provides computer resources to a networked terminal. In some distributed computing systems, users of a computer system may actually be accessing component parts that are shared among a number of users. The users can therefore access a virtual computer over a network, which will appear to the user as a single computer customized and dedicated for a single user.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A videoconferencing system, comprising:
at least one cluster node server;
a master server configured to communicate with the at least a cluster node server and an outside client over a wide area network;
each of the cluster node servers being configured to communicate with a plurality of cluster node clients, each of the cluster node servers being configured to send and receive audio and video information to and from the cluster node clients, and the cluster node servers further being configured to send and receive audio and video information to and from the master server; and
wherein the master server is configured to send and receive the audio and video information to and from each of the cluster node servers and the outside client such that each user of each outside client and each cluster node client can see, hear, and interact with each other in real time.

2. The videoconferencing system of claim 1, wherein the master server is configured to receive a plurality of video streams, the plurality of video streams comprising a video stream from the outside client and a video stream from each cluster node server, the master server being configured to generate a composite video stream containing downsampled images from each of the plurality of video streams.

3. The video conferencing system of claim 2, wherein each cluster node client provides a user interface for displaying the composite video stream generated by the master server.

4. The video conferencing system of claim 1, wherein each of the cluster node clients connects to one of the cluster node servers through a local area network connection.

5. The video conferencing system of claim 1, the cluster node servers each further comprising a local client to provide a conference attendee using the cluster node server with access to a video conference.

6. The video conferencing system of claim 1, wherein one of the cluster node servers is configured to receive a plurality of local video streams, each of the local video streams originating from a respective one of the cluster node clients, the one of the cluster node severs being further configured to select one of the local video streams based on one of a user selection and auto selection, and transmit the selected video stream to the master server.

7. The video conferencing system of claim 1, wherein one of the cluster node servers is configured to receive a plurality of local video streams, each of the local video streams originating from a respective one of the cluster node clients, the one of the cluster node servers being further configured to generate a local composite video stream incorporating each of the local video streams, and transmit the local composite video stream to the master server.

8. The videoconferencing system of claim 7, wherein the master server is configured to receive a plurality of video streams, the plurality of video streams including a video stream from the outside client and the local composite video stream from the one cluster node server, the master server being configured to generates a composite video stream containing downsampled images from each of the plurality of video streams.

9. A method for enabling a plurality of videoconference attendees to see and hear each other, the method comprising:
transmitting audio and video information from an outside client to the master node server over the wide area network;
transmitting audio and video information from a plurality of cluster node clients to a cluster node server;
transmitting at least a portion of the audio and video information received by the cluster node server from the cluster node clients to the master server;
combining audio and video information received by the master server into a composite audio and video stream for each of the outside client and cluster node server, and transmitting each composite audio and video stream to a corresponding one of the outside client and the cluster node server; and
transmitting the composite audio and video stream received by the cluster node server to the cluster node clients.

10. The method of claim 9, wherein the composite audio and video stream generated by the master server contains downsampled video streams from the outside client and the cluster node server.

11. The method of claim 9, wherein each cluster node client provides a user interface for displaying the composite audio and video stream generated by the master server.

12. The method of claim 9, wherein the cluster node server and the cluster node clients reside on a common local area network, and the transmitting of audio and video information from the plurality of cluster node clients comprises transmitting the audio and video information over the local area network.

13. The method of claim 9, further comprising passing audio and video information from a local client on the cluster node server to server software on the cluster node server, wherein the audio and video information received by the cluster node server includes audio and video information from the local client.

14. The method of claim 9, wherein the transmitting the at least a portion of the audio and video information received by the cluster node server from the cluster node clients comprises selecting one of local video streams based on one of a user selection or an auto selection, and transmitting the selected video stream to the master server.

15. The method of claim 9, wherein the transmitting the at least a portion of the audio and video information received by the cluster node server from the cluster node clients comprises receiving local video streams from the cluster node clients and generating a local composite video stream incorporating each of the local video streams, and transmitting the local composite video stream to the master server.

16. A graphical user interface for a videoconferencing system, the graphical user interface, comprising:
a video window, the video window displaying a master composite video stream originating from a master server, the master composite video stream comprising downsampled views, at least one view being a downsampled image of an outside attendee, the outside attendee being connected directly to the master server over a wide area network; at least one other view being a downsampled image of a local composite video stream, the local composite video stream originating from a cluster node server and comprising a plurality of local views of attendees connected to the cluster node server, the cluster node server generating the local composite video stream from a plurality of downsampled local streams originating from cluster node clients and transmitted to the cluster node server over a local area network.

17. The user interface of claim 16, wherein the cluster node clients and the cluster node server are directly connected to the local area network.

18. The user interface of claim 16, wherein the local composite video stream also includes a local view of an attendee using a local client on the cluster node server.

19. The user interface of claim 18, wherein a layout of local composite video stream and a layout of the master composite video stream are selectable by interacting with the video window using a pointing device at a selected one of the local client and the cluster node clients.

20. The user interface of claim 16, further comprising a broadcast select region, the broadcast select region allowing a selection between a transmitting the local composite stream and a video stream from one of the clients connected to the cluster node server.
